(19) United States
(12) Patent Application Publication
(10) Pub. No.: US 2025/0154069 A1
(43) Pub. Date: May 15, 2025

(54) METHOD AND DEVICE FOR PRODUCING A SILICON CARBIDE CONTAINING WORKPIECE

(71) Applicant: The Yellow SiC Holding GmbH, Berlin (DE)

(72) Inventor: Siegmund GREULICH-WEBER, Berlin (DE)

(73) Assignee: The Yellow SiC Holding GmbH, Berlin (DE)

(21) Appl. No.: 18/832,962

(22) PCT Filed: Jan. 27, 2023
(86) PCT No.: PCT/EP2023/052049

§ 371 Date: Jul. 25, 2024

(30) Foreign Application Priority Data
Feb. 1, 2022 (DE) 10 2022 102 373.7

(51) Int. Cl. C04B 35/573

(52) U.S. Cl. CPC C04B 35/573; C04B 2235/614; C04B 2235/656

(57) ABSTRACT

Disclosed are a method and an apparatus for producing a silicon carbide-containing workpiece, in which:
a blank (2) is held in a heated reactor (1),
a gas composition is fed into the reactor (1), the gas composition serving as a precursor for silicon carbide production and containing gaseous tetrachlorosilane as a silicon source and a hydrocarbon gas as a carbon source, and
the silicon carbide-containing workpiece is produced from the blank (2) under the action of the gas composition.

The invention relates to a method and an apparatus for producing a silicon carbide-containing workpiece.

Silicon carbide is an attractive material for many uses, due to its high hardness, its thermal conductivity and its special semiconductor properties.

EP 2094622 B1 discloses a method for producing a silicon carbide-containing workpiece, wherein a graphite blank with essentially the shape and dimensions of the workpiece to be produced is, within a reactor (furnace), embedded in a precursor that includes a granulate of SiO₂ which contains carbon.

In the furnace, the precursor and blank are then exposed to a temperature of around 1800° C. under an inert gas atmosphere. In carbothermal reactions, gas containing Si—C is released from the precursor, infiltrates the blank and transforms its material into silicon carbide. Thereby, the workpiece containing silicon carbide is created from the blank.

The storage and handling of a solid precursor of SiO₂ containing carbon for use in this technique is relatively simple. However, a solid precursor has limitations for the process in the furnace, as the possible amount of precursor in contact with the blank is limited, and it is difficult to feed the solid precursor into the furnace during the process.

In the neighboring field of coating the surface of a substrate with silicon carbide, it is known to deposit the coating from the gas phase on the non-porous substrate surface by means of chemical vapor deposition, CVD. Typically, the substrate surface is supplied with a gas containing methyltrichlorosilane (SiCH₃Cl₃, MTS) serving as a source for silicon and carbon, and optionally containing hydrogen (H₂) as a transport gas. Methyltrichlorosilane already provides Si and C in a stoichiometric ratio for the SiC coating.

In the method according to EP 2094622 B1, however, the granular precursor cannot simply be replaced by the H₂-MTS gas known from the CVD process, because the graphite blank is another carbon source that must be taken into account for the quantitative ratio of Si and C. Deviations from the stoichiometric ratio in the reaction product impair the attractive properties of the silicon carbide produced. If methyltrichlorosilane is used as a precursor in conjunction with a graphite blank, the Si—C ratio of the reaction product can only be controlled to a limited extent.

It is, therefore, an object of the invention to provide a method and an apparatus for producing a workpiece containing silicon carbide, which are more efficient and can be controlled more precisely than the prior art.

This object is solved by a method and an apparatus as set forth in the appended claims.

The invention uses a gas composition containing gaseous tetrachlorosilane (SiCl₄) as a silicon source and a hydrocarbon gas as a carbon source, as a precursor for the formation of silicon carbide in the production of a silicon carbide-containing workpiece. If necessary, further silicon and/or carbon material sources may be present. The use of a gas composition as precursor enables the simple dosing and introduction of the precursor into a reactor for the production of the workpiece. The use of different gases for the silicon source and for the carbon source in the gas composition allows the simple and precise adjustment of the quantity ratio between silicon and carbon in the precursor.

The hydrocarbon gas as a carbon source is typically a short-chain alkane such as methane, ethane, propane or butane and typically methane and/or butane. The tetrachlorosilane as a silicon source has the additional advantage over the methyltrichlorosilane known from CVD technology that it is non-flammable and therefore easy to handle and is also relatively inexpensive.

The gas composition may also contain hydrogen as a carrier gas.

The gas composition is advantageously used for gas phase infiltration (chemical vapor infiltration, CVI) of a blank from which the silicon carbide-containing workpiece is produced by infiltrating the blank at least close to its surface with components of the gas composition and transforming the material of the blank at least partially into silicon carbide. Compared to a solid precursor, the gas composition can be easily supplied during the process to the reactor in which the blank is exposed to the gas phase infiltration.

In this process, the surface of the blank is typically porous. The invention is particularly suitable for infiltrating a carbon or graphite blank.

It is particularly advantageous that the quantitative ratio between tetrachlorosilane and carbon hydrogen gas in the gas composition can be adjusted in such a way that stoichiometric silicon carbide is eventually produced in the blank even if the carbon-containing components and the silicon-containing components of the gas have different diffusion behaviors in the pores of the blank, or if carbon is present in the blank, such as in the case of a graphite blank. Also, the quantity ratio can be changed during the process, for example to take account of a narrowing of the pores in the blank and a decrease of the carbon available for transformation into SiC in the blank during the process.

Preferred embodiments of the invention are described below with reference to the drawing in which:

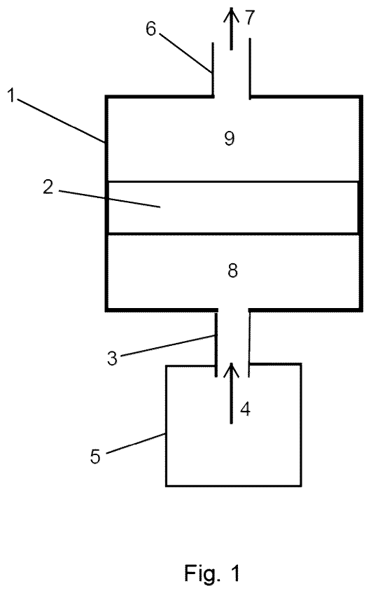

FIG. 1 schematically shows an apparatus for producing a silicon carbide-containing workpiece according to embodiments of the invention.

The apparatus for producing a silicon carbide-containing workpiece as shown in FIG. 1 comprises a furnace serving as a heatable reactor 1, which accommodates a blank 2 made of porous carbon-containing material. The blank 2 essentially has the shape and dimensions of the silicon carbide-containing workpiece to be produced. A suitable carbon-containing material is graphite, which can be easily machined and provided in the shape of the workpiece to be produced. Alternatively, the blank can also be a product made of carbon fibers, for example.

The reactor 1 has an inlet 3 connected to a gas source 5 for introducing a gas composition from the gas source 5 into the reactor 1 in the direction of arrow 4. Further, the reactor 1 has an outlet 6 for discharging gaseous reaction products from the reactor 1 in the direction of arrow 7.

The gas composition supplied by the gas source 5 in use is a mixture containing gaseous tetrachlorosilane (SiCl₄) as a silicon source, a hydrocarbon gas as a carbon source and hydrogen as a transport gas. The hydrocarbon gas is preferably an alkane, in particular methane and/or butane. The gas source 5 can introduce the constituent parts of the gas composition separately into the reactor 1. Preferably, however, it combines the components beforehand to form the mixture and feeds the mixture through the inlet 3 into the reactor 1. Thereby, it can control the quantitative ratio of silicon to carbon in the gas composition.

The gas composition fed into the reactor 1 is reacted with the blank 2 at a temperature in the range of 900 to 1300° C. Components from the gas composition infiltrate the porous blank 2 and cause at least partial transformation of the material of the blank 2 to silicon carbide in a CVI (chemical vapor infiltration) process, thus producing the silicon carbide-containing workpiece.

With regard to the carbon already present in the blank 2, the gas composition fed into the reactor 1 by the gas source 5 should contain fewer carbon atoms than silicon atoms, so that the material of the blank 2 is transformed into stoichiometric silicon carbide, SiC, as a result. In order to account for a decrease in the available carbon in the blank 2 during the process, the gas source 5 can control the gas composition such that the proportion of hydrocarbon gas in the gas composition increases in relation to the proportion of tetrachlorosilane in the gas composition during the process.

The CVI processes can basically be isothermal (at a uniform, spatially equalized temperature of the entire blank 2), isobaric (at a uniform, spatially equalized pressure of the gas composition on the surface of the blank 2), or can take place under a temperature gradient and/or pressure gradient over the blank 2 (gradient process).

In an isothermal-isobaric CVI process, the blank 2 is freely arranged in the reactor so that it is essentially accessible on all its sides by the gas composition (not shown). Components of the gas composition diffuse into the blank 2 essentially from all sides, driven by concentration gradients. The temperature in reactor 1 is maintained at a uniform value in the range from 900 to 1300° C.

In the gradient process with temperature and pressure gradients, the blank 2 is inserted into the reactor 1 of the embodiment as shown in the FIGURE in such a way that the blank divides the interior of the reactor into a first chamber 8 connected to the inlet 3 and a second chamber 9 connected to the outlet 6. The introduction of the gas composition from the gas source 5 causes a higher pressure in the first chamber 8 than in the second chamber 9 and thus causes a pressure gradient from the side of the blank 2 facing the inlet 3 to its side facing the outlet 6. The second chamber 9 is heated to a temperature in the range of 900 to 1300° C. and the first chamber 8 is kept at a temperature that is lower than that of the second chamber 9 by weaker heating or even by cooling, so that a temperature gradient is created from the side of the blank 2 facing the inlet 3 to its side facing the outlet 6. The pressure and temperature gradients promote the diffusion of the constituent parts of the gas composition into the blank 2 and thus its infiltration and transformation into the silicon carbide-containing workpiece.

The blank 2, suitably made of porous graphite, is converted (transformed) into silicon carbide in its depth and not just coated with silicon carbide on its surface as in CVD or PVD processes.

The described methods for producing a workpiece containing silicon carbide therefore have the advantage that the precursor is provided in the form of a gas composition. In this form, the precursor can be continuously fed into the reactor 1 during the process without having to interrupt the process to refill the precursor, as is often the case when using a solid precursor. In addition, the gas composition contains different gases serving as silicon and as carbon sources and thus allows simple and precise adjustment of the quantity ratio between silicon and carbon in the precursor.

1. A method for producing a silicon carbide-containing workpiece, comprising:
holding a blank (2) in a heated reactor (1),
feeding a gas composition into the reactor (1), said gas composition serving as a precursor for silicon carbide production and containing gaseous tetrachlorosilane as a silicon source and a hydrocarbon gas as a carbon source, and
producing the silicon carbide-containing workpiece from the blank (2) under the action of the gas composition.

2. A method according to claim 1, wherein the reactor (1) is heated to a temperature in the range from 900 to 1300° C.

3. A method according to claim 1, wherein the gas composition further comprises hydrogen as a carrier gas.

4. A method according to claim 1, wherein the blank (2) includes a carbon-containing material which is transformed into silicon carbide at least near its surface.

5. A method according to claim 1, wherein the blank (2) is porous, and components from the gas composition infiltrate the blank (2).

6. A method according to claim 1, wherein the gas composition fed into the reactor (1) is controlled such that the proportion of hydrocarbon gas in the gas composition increases over time in relation to the proportion of tetrachlorosilane in the gas composition.

7. An apparatus for producing a silicon carbide-containing workpiece, comprising:
a heatable reactor (1) which is configured to maintain a carbon-containing blank (2) at a temperature which permits its transformation into the silicon carbide-containing workpiece, and
a source (5), connected to the reactor (1), of a gas composition serving as a precursor for silicon carbide production and containing gaseous tetrachlorosilane as a silicon source and hydrocarbon gas as a carbon source.
